(19) United States
(12) Patent Application Publication
(10) Pub. No.: US 2004/0043184 A1
(43) Pub. Date: Mar. 4, 2004

(54) Flooring article with soft, skid-resistant backing construction and process of manufacture

(76) Inventors: Seiin Kobayashi, Yamagata (JP); Thomas D. Nord, Yonezawa-shi (JP)

Correspondence Address: Milliken & Company, P.O. Box 1927, Spartanburg, SC, 29304, US

(21) Appl. No.: 10/228,584

(22) Filed: Aug. 27, 2002

(51) Int. Cl. B32B 33/00; B32B 5/26

(52) U.S. Cl. 428/95; 442/239; 442/246; 442/268

(57) ABSTRACT

There is provided a flooring article having a composite structure, whose soft secondary backing material and mesh fabric prevent damage to the floor on which the article is placed and which prevent the flooring article from sliding during use. The soft backing material prevents the flooring on which the rug is placed from being scratched or abraded by the article. The mesh fabric, when incorporated in the flooring composite, prevents the finished article from sliding across the flooring surface during use.

### TECHNICAL FIELD

The present disclosure relates to a flooring article with a backing that is both soft and skid-resistant. The present flooring construction includes a soft backing that will not abrade or slide across other flooring on which the article is placed (such as hardwood flooring). The construction comprises four basic layers, a textile upper surface having a primary substrate, an adhesive layer positioned between the textile upper surface and a secondary backing, a soft secondary backing, and a coated mesh fabric. These layers are secured to one another by subjecting the layers to heat and pressure, which cause the adhesive layer and the coated mesh fabric to melt and fuse to adjacent layers. The resulting composite has a backing that is soft, skid-resistant, and durable.

### BACKGROUND

Many flooring articles, such as area rugs or mats, include a backing surface covered with latex or similar material. The problem with articles having a latex backing surface is that their rigidity tends to abrade flooring surfaces on which such articles are placed. Additionally, many manufacturers are concerned by the use of latex, because of processing difficulties (for example, emissions of volatile organic chemicals).

An alternative to latex backing surfaces is the use of a felt-like material as a backing. The felt material, while soft, tends to cause the flooring article to slide across the surface on which the article is placed. This tendency can pose a slipping danger to pedestrians crossing the article.

### SUMMARY

In at least one embodiment, there is provided a flooring article having a composite structure, whose soft secondary backing material and/or mesh fabric address these issues. The soft backing material prevents damage to the flooring surface on which the rug is placed. The mesh fabric, when incorporated in the flooring composite, prevents the finished article from sliding across the flooring surface during use. For these reasons, the present combination represents a useful advancement over the prior art.

### BRIEF DESCRIPTION OF THE DRAWING

FIG. 1 is a cross-sectional view of a preferred embodiment of the present flooring article; and

FIG. 2 is an exploded view of the present construction, as seen from the rear side of the flooring article.

### DETAILED DESCRIPTION

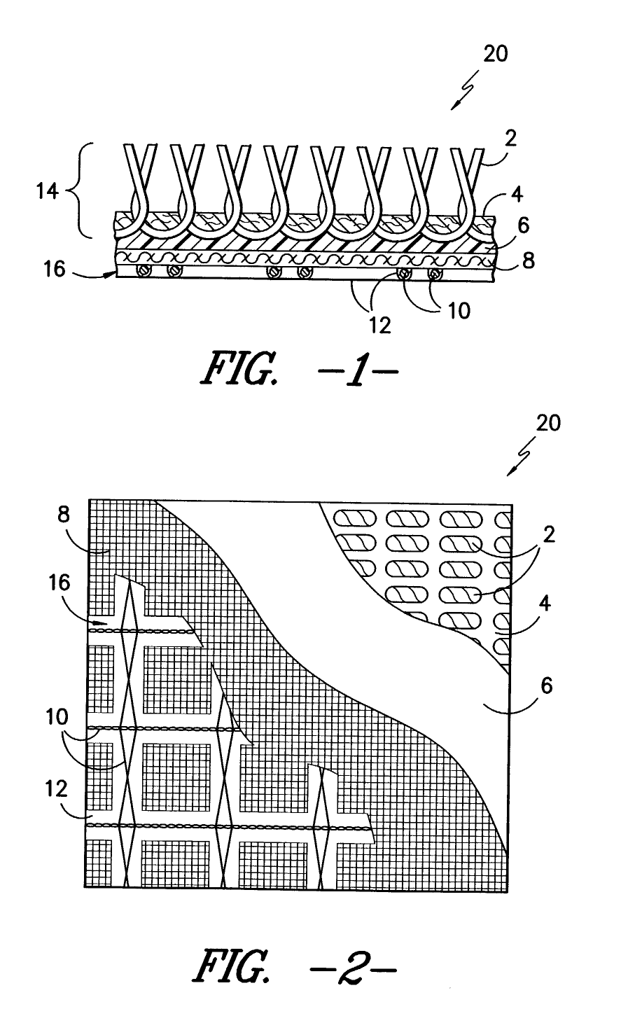

In a preferred embodiment shown in FIG. 1, flooring article 20 has a textile upper surface 14 having yarns 2 and a primary substrate 4 in which yarns 2 are secured; an adhesive layer 6 positioned between primary backing or substrate 4 and secondary backing or substrate 8; a secondary backing or substrate 8; and an open mesh layer 16 whose coating 12 is fused into the flooring construction.

Yarns 2 are comprised of natural and/or synthetic fibers. By way of example, yarns 2 may be nylon, polyester, acrylic, polypropylene, cotton, wool, or any combination thereof. Nylon is the preferred fiber type because of its durability, pile resistance, and colorfastness when dyed. Alternatively, solution dyed synthetic yarns may also be used. Yarns 2 of textile upper surface 14 are preferably attached to and/or through the primary backing or substrate 4, as will be described.

Primary substrate 4, in which yarns 2 are preferably placed, is comprised of any woven or nonwoven material, such as, but not limited to, nylon, polypropylene, polyester, cotton, wool, acrylic, glass, or combinations thereof. One preferred primary substrate is a polyester nonwoven that is coated with nylon and, more preferably, that is dyed a dark color to mask the appearance of the substrate and to emphasize the color of the yarns. Speaking of this preferred substrate, the nylon component of substrate 4 tends to accept the dye used for yarns 2, further masking substrate 4 from users. One important aspect of using a nylon-coated polyester nonwoven substrate is its dimensional stability, particularly during dye processing, during the backing formation process, and during laundering. Alternately, a woven polypropylene substrate with either a nonwoven nylon cap or a nonwoven polypropylene cap may also be used.

Texile upper surface 14 may comprise a tufted cut-pile surface, a tufted loop-pile surface, a tufted multi-level pile, a tufted combination of loop and cut pile, a needle-punched surface, a bonded pile surface, a woven fabric, a knit fabric, a nonwoven fabric, or a combination thereof. Preferably, textile upper surface 14 is a tufted cut-pile surface, because of its appearance, softness, and dust control attributes. Textile upper surface 14 may further be patterned by methods such as, but not limited to, dye injection, graphic tufting, screen printing, pad dyeing, flocking, or combinations thereof. Dye injection printing is preferred because of the ability to create intricate and customized designs.

Adhesive layer 6 serves to secure yarns 2 in primary substrate 4. Adhesive layer 6 is typically a solid material that softens when subjected to heat and pressure. This softening creates cohesion between primary substrate 4 and secondary backing substrate 8. Adhesive layer 6 may be comprised of any number of materials, including, but not limited to, natural rubbers, synthetic polyisoprene rubbers, styrene-butadiene rubbers, acrylonitrile-butadiene-sytrene rubbers, ethylene propylene rubbers, urethanes, polypropylene, polyethylene, nylon, polyester, acrylonitrile-butadiene-styrene, polyvinyl chloride, thermoplastic elastomers, thermoset plastics, low-melt thin films, or any combinations thereof. The use of thermoplastic elastomer is preferred because of its adhesion properties and its ease of use in manufacturing.

Secondary backing or substrate 8 is useful in providing a soft backing for flooring article 20 and in providing dimensional stability to flooring article 20. Secondary backing or substrate 8 also decreases the likelihood of adhesive layer 6 cracking or breaking with use of flooring article 20. In addition, secondary backing or substrate 8 provides a uniform appearance on the reverse side of flooring article 20. Cotton, polyester, polypropylene, nylon, acrylic, or any combinations thereof may be used to create secondary backing substrate 8, which may be a woven, nonwoven, or knit material. The use of a cotton or polyester woven material is preferred for softness.

The final component of flooring article 20 is a mesh fabric 10 that has a coating 12 surrounding the mesh. Coated mesh fabric 16 adds dimensional stability to flooring article 20 and prevents flooring article 20 from sliding during use. Coated mesh fabric 16 may comprise any woven, nonwoven, or knit material (shown as fabric 10 in the drawings), having a substantially open configuration; woven fabrics are preferred for the uniformity of the mesh. The openings in mesh fabric 10 should preferably be from about 0.125 inches to about 1.5 inches, and more preferably be about 0.5 inches. Fabric 10 itself may be comprised of cotton, polyester, polypropylene, nylon, acrylic, or any combination thereof, although cotton or polyester is more preferred. When using cotton or polyester, it may be desirable to pre-shrink the fabric before coating.

Fabric 10 is coated with, by way of example, natural rubbers, synthetic polyisoprene rubbers, styrene-butadiene rubbers, acrylonitrile-butadiene-sytrene rubbers, ethylene propylene rubbers, urethanes, polypropylene, polyethylene, nylon, polyester, acrylonitrile-butadiene-styrene, polyvinyl chloride, thermoplastic elastomers, thermoset plastics, or any combinations thereof. The coating 12 is shown in FIGS. 1 and 2. The preferred mesh fabric 16 is a woven fabric 10 with a latex coating 12, in which the fabric component 10 is made from cotton or polyester. It has been found that production of flooring article 20 is most successful when the melting points of coating 12 and adhesive layer 6 are comparable.

Flooring article 20 is produced by placing the component pieces on top of one another as in a continuous vulcanization press or shuttle vulcanization press. The process may be run continuously or in batch mode. The layers are positioned as follows: coated mesh fabric 16, secondary backing substrate 8, adhesive layer 6, and textile upper surface 14, which comprises primary substrate 4 and yarns 2. It should be noted that coated mesh fabric 16 should be positioned toward the heating platen of the vulcanization chamber (that is, if the heating platen is at the top of the chamber, then the order described above should be reversed).

The pre-assembly is then subjected to heat and pressure, as would be found in a vulcanization chamber. The heat and pressure of the vulcanization environment cause adhesive layer 6 and coating 12 of mesh fabric 16 to melt and fuse the component layers together. Temperatures in the range of about 180° C. to about 220° C. are preferred, while temperatures in the range of about 195° C. to about 200° C. are more preferred. Pressures ranging from about 15 pounds per square inch (gauge) (p.s.i.g.) to about 50 p.s.i.g. are preferred, while a pressure of about 30 p.s.i.g. is more preferred.

The composite may be edge-trimmed and a serger may be used to complete the edges of flooring article 20. Alternatively, edging tape may be sewn around the perimeter of flooring article 20 to create a finished edge. Yet another alternative is to create a solid edge formed from natural rubbers, synthetic polyisoprene rubbers, styrene-butadiene rubbers, acrylonitrile-butadiene-sytrene rubbers, ethylene propylene rubbers, urethanes, polypropylene, polyethylene, nylon, polyester, acrylonitrile-butadiene-styrene, polyvinyl chloride, thermoplastic elastomers, thermoset plastics, or any combinations thereof.

Flooring article 20 preferably has a backing that is soft, skid-resistant, and durable. Such a backing prevents damage to flooring surfaces on which flooring article 20 is placed and prevents flooring article 20 from sliding during use.

What is claimed is:

1. A soft and skid-resistant backing for a flooring article, said flooring article having a textile upper surface secured to a primary substrate, wherein said backing comprises a textile material that is attached to said primary substrate and a coated mesh fabric whose coating is fused to said textile material.

2. The backing of claim 1, wherein said textile material is a woven fabric.

3. The backing of claim 1, wherein said textile material is comprised of cotton yarns.

4. The backing of claim 1, wherein said mesh fabric is coated with latex.

5. The backing of claim 1, wherein said mesh fabric includes a plurality of openings having an average size in the range of about 0.125 inches to about 1.5 inches.

6. The backing of claim 5 wherein said mesh fabric includes a plurality of openings having an average size of about 0.5 inches.

7. A flooring article having a soft, skid-resistant backing, said article comprising:
a textile upper surface having a plurality of yarns attached to a primary substrate;
an adhesive layer;
a textile secondary backing substrate; and
a coated mesh fabric whose coating is fused to said secondary backing.

8. The flooring article of claim 7, wherein said textile upper surface has a surface that is selected from the group consisting of a tufted cut-pile, a tufted loop-pile, a tufted multi-level pile, a tufted combination of loop and cut pile, a needle-punched surface, a bonded pile, a woven fabric, a knit fabric, a nonwoven fabric, and combinations thereof.

9. The flooring article of claim 8, wherein said textile upper surface is a tufted cut-pile construction.

10. The flooring article of claim 7, wherein said adhesive layer is selected from the group consisting of natural rubbers, synthetic polyisoprene rubbers, styrene-butadiene rubbers, acrylonitrile-butadiene-sytrene rubbers, ethylene propylene rubbers, urethanes, polypropylene, polyethylene, nylon, polyester, acrylonitrile-butadiene-styrene, polyvinyl chloride, thermoplastic elastomers, thermoset plastics, and combinations thereof.

11. The flooring article of claim 10, wherein said adhesive layer is thermoplastic elastomer.

12. The flooring article of claim 7, wherein said secondary backing substrate is a woven fabric.

13. The flooring article of claim 7, wherein said mesh fabric is coated with latex.

14. The flooring article of claim 7, wherein said mesh fabric comprises cotton yarns that are coated with latex.

15. A process for producing a flooring article with a soft, skid-resistant backing, said process comprising the steps of:
(a) creating a pre-assembly by overlapping a textile upper surface having a plurality of yarns attached to a primary substrate; an adhesive layer; a secondary backing substrate; and a coated mesh fabric; and
(b) subjecting said pre-assembly to heat and pressure to fuse the pre-assembly together and create a flooring article.

16. The process of claim 15 wherein the perimeter of said flooring article is subjected to serging after step (b).

17. The process of claim 15 wherein the perimeter of said flooring article is covered with edging tape, said edging tape being sewn to the perimeter after step (b).

18. The process of claim 15 wherein said pre-assembly is subjected to heat and pressure in a vulcanization chamber.

19. The process of claim 18 wherein said pre-assembly is subjected to heat created from temperatures ranging from about 180° C. to about 220° C.

20. The process of claim 19 wherein said pre-assembly is subjected to heat created from temperatures ranging from about 195° C. to about 200° C.

21. The process of claim 18 wherein said pre-assembly is subjected to pressure ranging from about 15 p.s.i.g. to about 50 p.s.i.g.

22. The process of claim 21 wherein said pre-assembly is subjected to pressure of about 30 p.s.i.g.
